(19) United States
(12) Patent Application Publication
(10) Pub. No.: US 2010/0088945 A1
(43) Pub. Date: Apr. 15, 2010

(54) Hardened Purse Ring

(76) Inventor: John F. Gois, La Mesa, CA (US)

Correspondence Address: NYDEGGER & ASSOCIATES, 348 OLIVE STREET, SAN DIEGO, CA, 92103, US

(21) Appl. No.: 12/250,260

(22) Filed: Oct. 13, 2008

(51) Int. Cl. A01K 73/12; A01K 75/00; A01K 73/00

(52) U.S. Cl. 43/14; 43/8

(57) ABSTRACT

A purse ring for interconnecting a purse seine to a purse line is disclosed. Structurally, the purse ring includes a frame defining an aperture, with two rollers mounted across the aperture. As constructed, the rollers and the first and second sides of the frame between the rollers define a periphery around a passageway for receiving the purse line. Importantly, the portion of the first side of the frame adjacent the distal roller includes a hard facing in order to reduce wear. Also, the purse ring includes a cable release arm pivotally mounted as a portion of the second side of the frame, a sleeve for engaging the free end of the cable release arm to the frame, and a lock for holding the sleeve in place.

### FIELD OF THE INVENTION

The present invention pertains to seine equipment used in fishing operations. More specifically, the present invention pertains to purse rings which connect the fishing net to a pursing cable or purse line. The present invention is particularly, but not exclusively, useful in purse seiner operations wherein a purse line is drawn through a plurality of purse rings to close the seine and retrieve fish caught in the seine.

### BACKGROUND OF THE INVENTION

In commercial fishing operations, the method of fishing known as purse seine fishing is an effective and widely used technique. The method is conceptually simple. A seine, or net, is fitted at one end with buoyant devices (e.g. floats) and at the other end with weighting devices (e.g. sinkers). As the seine is deployed in a rough circle, the weighted end of the seine submerges to cause the seine to hang essentially vertically in the water. To provide for seine retrieval, a purse line is attached to the weighted end of the seine by a plurality of connectors, known as purse rings. As the purse line is tightened by fishermen on the fishing vessel, the weighted end of the seine is drawn together to enclose fish within the seine. The weighted end, now pursed, is raised and drawn toward the fishing vessel. Simultaneously, support craft retrieve and draw in the buoyed end of the seine. In this way, fish are trapped in the seine as it is retrieved.

During seine retrieval, the purse line, through its interaction with the purse rings, is used to both purse the seine and draw it toward the fishing vessel. As can be easily imagined, the forces which are generated between the purse line and the purse ring during these operations can be very substantial. Indeed, these forces can cause significant frictional erosion and wear on both the purse line and the surface of the purse rings. The eventual results are a complete failure of the purse rings and a fraying of the purse line which causes the purse line to snag on the netting. In either event, the operation is compromised and the purse rings may need to be replaced.

Recent developments in the commercial fishing area have compounded the problem of purse ring wear because many of the now preferred fishing grounds are located in the Western Pacific Ocean. It happens that purse seiner operations in the Western Pacific require deeper deployment of the seines than thermoclines in the Western Pacific that often result in deeper schooling of food fish. Consequently, with the deployment of seines, the forces required to retrieve the seines (e.g. forces between the purse line and the purse rings) are greatly increased. As a further consequence, standard purse rings, such as are used in other oceans of the world, are generally inadequate for use in the Western Pacific.

In light of the foregoing, the present invention recognizes the need to significantly reduce purse ring wear to permit efficient seiner operations at greater depths in the ocean and to prolong the useful life of purse rings used in seiner operations regardless of depth. It is therefore an object of the present invention to provide a purse ring for use in purse seiner fishing operations which has a relatively long period of usefulness. It is a further object of the present invention to provide a purse ring for seiner operations that reduces frictional wear on the purse ring when a purse line is drawn through it during seine retrieval operations. It is yet a further object of the present invention to provide a purse ring for use in purse seiner operations that facilitates purse line insertion into or withdrawal from the purse ring. Another object of the present invention is to provide a purse ring for purse seiner fishing operations which is easy to install and use, relatively easy to manufacture, and comparatively cost-effective.

### SUMMARY OF THE INVENTION

In the present invention, a purse ring is provided for engagement with the bridle line of a seine for pursing the seine with a purse line during deep-sea fishing operations. Importantly, the purse ring is designed to resist wear through the use of hard facing inserts. Also, the purse ring facilitates insertion and removal of purse lines during use. Further, the purse ring provides for automatic use of a locking pin.

Structurally, the purse ring comprises an oblong-shaped frame that defines a plane and circumscribes an aperture. The frame may be considered to consist of two ends that are interconnected by two sides. For purposes of the present invention, two rollers interconnect the sides by bridging the aperture. As a result, the rollers and the sides define a periphery around a passageway for receiving the purse line. In order to reduce wear on the sides caused by the purse line, the sides include hard facing. Alternatively or additionally, side rollers may be embedded into the sides to reduce friction with the purse line.

Also, the purse ring includes a cable release arm that is pivotally mounted on the frame as a portion of one of the sides. Operationally, the cable release arm is canted and pivotable to interrupt the periphery to move the purse line into and out of the passageway. For the present invention, the cable release arm includes a pivot arm and a sleeve. Structurally, the pivot arm has an end that is attached to the frame via a pivot pin. Further, the pivot arm forms a key guide for engaging the sleeve. Specifically, the sleeve forms a channel that receives the pivot arm. A bolt spans the channel and is received within the key guide to provide for sliding engagement between the pivot arm and the sleeve. Further, the sleeve includes a flared end that is able to ride over the pivot pin to facilitate a full range of motion for the cable release arm when pivoting.

Also, the sleeve is provided with a lateral opening that connects to the channel. When the sleeve is extended, a portion of the frame is received within the channel. Importantly, a locking pin can be depressed to allow the sleeve to slide over the portion of the frame. When the sleeve reaches its fully extended configuration, the locking pin extends into the lateral opening to lock the sleeve in place. In order to simplify use of the purse ring, the sleeve is provided with a notch that engages and automatically depresses the locking pin during extension of the sleeve.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top view of a fishing vessel engaged in seiner operations;

FIG. 2A is a top perspective view of the preferred embodiment of the purse ring engaged with a bridle line and purse line and showing the cable release arm in its closed configuration;

FIG. 2B is a top perspective view of the purse ring of FIG. 2A with the cable release arm in its open configuration;

FIG. 2C is a side perspective view of the purse ring of FIG. 2B;

FIG. 3A is a perspective view of the sleeve in the purse ring shown in FIGS. 2A-2C;

FIG. 3B is a cross sectional view of the sleeve of FIG. 3A; and

FIG. 4 is a cross sectional view showing the connection between a roller and the frame of the purse ring.

### DESCRIPTION OF THE PREFERRED EMBODIMENTS

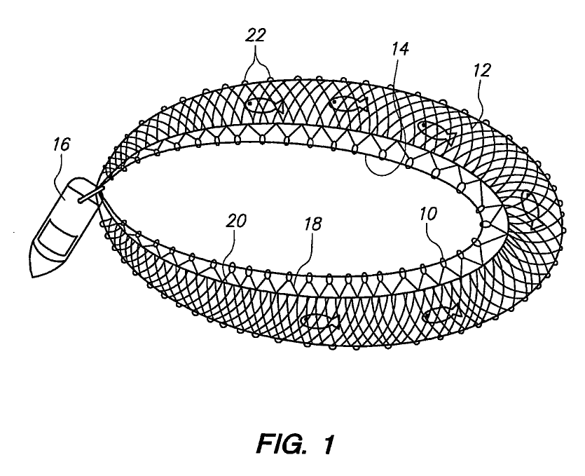

FIG. 1 shows a top overhead view of a purse seiner in operation using a plurality of purse rings designated 10. As shown, the purse rings 10 interconnect a seine 12 and a purse line 14 during the fishing operations conducted by a seiner vessel 16. For purposes of the present invention, it is to be appreciated that the purse line 14 may be either a cable, or a rope. More specifically, purse rings 10 are attached to the seine 12 with bridle lines 18 which are, in turn, attached to the seine 12 by a chain 20. Similar to the various embodiments for the purse line 14, the bridle lines 18 may be cables, ropes or chains. Further, floats 22 are connected to the seine 12 to provide buoyancy to maintain one side of the seine 12 at or near the water's surface. At the same time, the chain 20 and purse rings 10 act as sinkers to vertically orient the seine 12. As a result, the seine 12 is positioned to encircle schools of fish. When fish are encircled, they may be caught by pursing and retrieving the seine 12. This requires the interaction of purse line 14 with the plurality of purse rings 10.

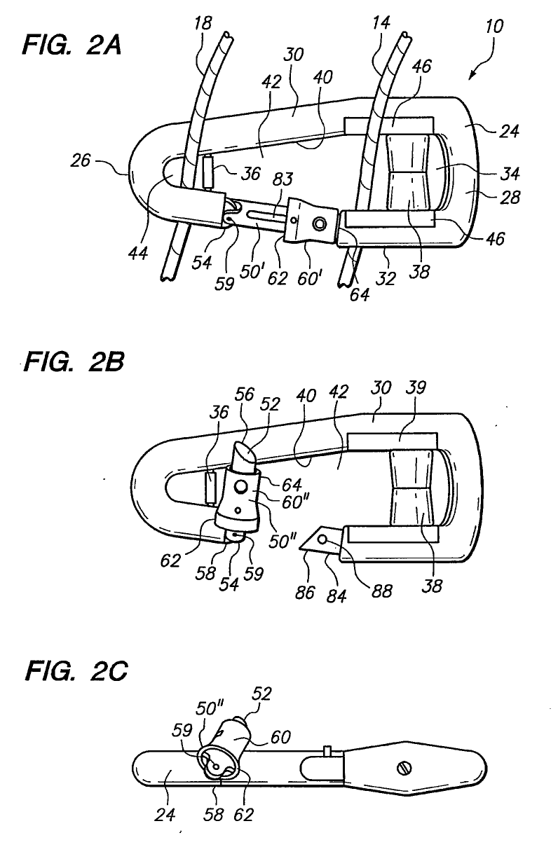

In FIG. 2A, a more detailed perspective view of an individual purse ring 10 is provided. As shown in FIG. 2, purse ring 10 comprises a frame 24 which may generally be of any shape that is efficient for connecting purse line 14 to bridle line 18. As depicted in FIG. 2, the preferred ring 10 is substantially oblong in shape. Also, purse ring 10 is preferably made of hardened steel and should be hard enough to resist frictional wear. Further, the elements of purse ring 10 should be chemically compatible with each other and with the materials of other components of seiner operations so as to minimize the effects of corrosion.

Still referring to FIG. 2A, it can be seen that frame 24 includes a proximal end 26 and a distal end 28. Further, two sides 30 and 32 interconnect the ends 26, 28 to define an aperture 34. As shown in FIG. 2A, the ring 10 includes a proximal roller 36 that interconnects the sides 30, 32 and bridges the aperture 34. Also, the ring 10 includes a distal roller 38 that further interconnects the sides 30, 32. With this structure, it can be seen that the sides 30, 32 and the rollers 36, 38 define a periphery 40 around a passageway 42 that receives the purse line 14. Further, the proximal end 26 and proximal roller 36 form an opening 44 for receiving the bridle line 18. Typically, during pursing operations, the purse line 14 rides along the distal roller 38 and the sides 30, 32 adjacent the distal roller 38. Therefore, the purse ring 10 is provided with hard facing 46 along both sides 30, 32 adjacent the distal roller 38. For purposes of the present invention, the hard facing 46 is comprised of at least one layer of a metal having improved strength and wear resistance such as Tube Alloy 240-O manufactured by McKay.

As shown in FIG. 2A, the proximal roller 36 is cylindrical. Further, the distal roller 38 is substantially cylindrical, but includes a slight taper toward its center to form a guide which facilitates a more efficient rolling contact of the distal roller 38 with purse line 14. Further, each roller 36, 38 is connected to frame 24 to provide for substantially free rotation and consequent reduced frictional wear during use.

In FIG. 2B, the illustrated embodiment of the purse ring 10 includes a side roller 39 mounted for rotation on the side 30. Structurally, the side roller 39 has an axis of rotation that is substantially perpendicular to the axis of rotation for the rollers 36, 38.

Cross-referencing FIG. 2A with FIGS. 2B and 2C, the ring 10 is shown to include a canted cable release arm 50 along the side 32 of the frame 24. Structurally, the canted cable release arm 50 includes a pivot arm 52 which is formed with an end 54 and an end 56. As shown in FIG. 2C, the frame 24 includes an extension 58 that is canted with respect to the frame 24. Further, the pivot arm 52 is pivotably mounted to the extension 58 via a pin 59. With this engagement, the pivot arm 52 is able to clear the side 30 of the frame 24 as it pivots from the closed configuration 50′ shown in FIG. 2A to the open configuration 50″ shown in FIGS. 2B and 2C. As shown, the pivot arm 52 is able to clear the side 30 of the frame 24 and pivot inwardly toward the proximal roller 36 until the pivot arm 52 is substantially parallel to the proximal roller 36. It will be appreciated that when pivot arm 52 is pivoted to the open configuration 50″, it interrupts the periphery 40 to allow the purse line 14 to be moved into and out of the passageway 42.

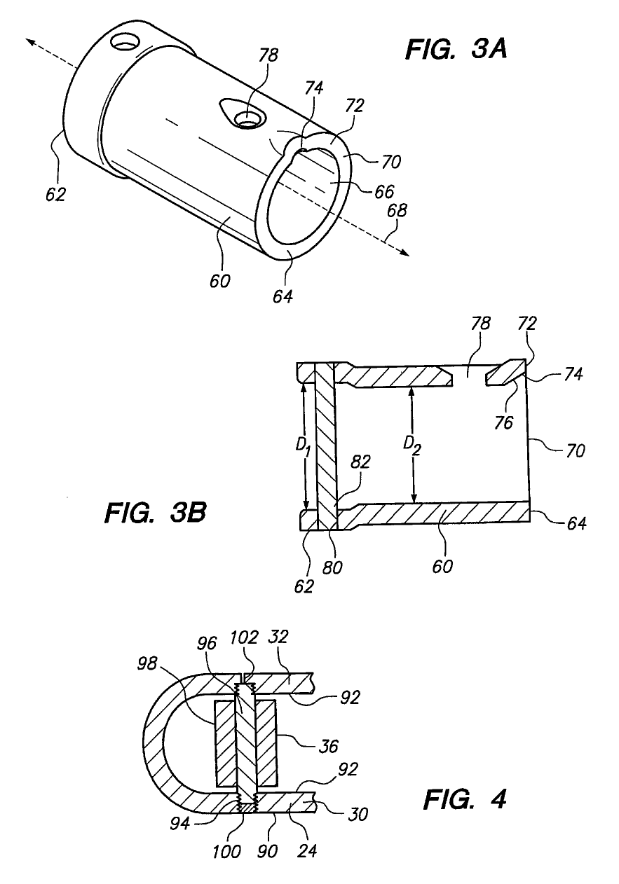

Further, the cable release arm 50 is provided with a sleeve 60 that has a flared proximal end 62 and a distal end 64. Referring to FIGS. 3A and 3B, the structure of the sleeve 60 may be more easily understood. As illustrated, the sleeve 60 forms a channel 66 that extends along an axis 68 from the proximal end 62 to the distal end 64. As seen in FIGS. 2A-2C, the channel 66 slidably receives the pivot member 52. As shown in FIG. 3A, at its distal end 64, the sleeve 60 has an end face 70 with a surface 72 that is substantially perpendicular to the axis 68. As shown, a notch 74 is formed in the sleeve 60 at the end face 70. Referring to FIG. 3B, it may be seen that the notch 74 includes a sloping surface 76 that forms an angle of about forty-five degrees with the end face surface 72.

As seen in FIGS. 3A and 3B, the sleeve 60 also forms a lateral opening 78 to the channel 66. Importantly, this lateral opening 78 is axially aligned with the notch 74 as detailed below. Further, the sleeve 60 includes apertures 80 for receiving a bolt 82 to engage the sleeve 60 with the pivot arm 52 as shown in FIGS. 2A-2C. Specifically, the pivot arm 52 forms a key guide 83 that slidingly receives the bolt 82. In FIG. 3B, it can be seen that the flared proximal end 62 of the sleeve 60 has an inner diameter D₁ while the rest of the sleeve 60 has an inner diameter D₂, with D₁>D₂. Referring back to FIG. 2A, the sleeve 60 is shown in an extended position 60′ in which the distal end 64 engages the frame 24. Specifically, the frame 24 includes an abutment member 84 (shown in FIG. 2B) that is received within the channel 66 when the cable release arm 50 is in the closed configuration 50′ and the sleeve 60 is in the extended position 60′. As a result, the sleeve 60 prevents pivotable movement of the cable release arm 50 when extended about the abutment member 84. Further, the ring 10 provides for the ability to lock the sleeve 60 in the extended position 60′.

As shown in FIG. 2B, the ring 10 provides a locking pin 86 on the abutment member 84. Specifically, the locking pin 86 is positioned in a slot 88 formed in the abutment member 84 and is biased outward from the slot 88. After the cable release arm 50 is closed, the sleeve 60 may be extended to engage the abutment member 84. During the extension of the sleeve 60, the sloping surface 76 of the notch 74 contacts and automatically depresses the locking pin 86. When the sleeve 60 is fully extended, the locking pin 86 reaches and extends through the lateral opening 78 in the sleeve 60. As a result, the locking pin 86 holds the sleeve 60 in the extended position 60′.

When the sleeve 60 is disengaged from the locking pin 86 and moved to its retracted position 60″, the flared proximal end 62 of the sleeve 60 rides over the end 54 of the pivot arm 52. As a result, the sleeve 60 does not interfere with the pivoting capability of the pivot arm 52. This allows the pivot arm 52 to be pivoted to be substantially parallel to the proximal roller 36 and facilitates the removal of the purse line 14 from the passageway 42.

Referring now to FIG. 4, the connection of a roller 36 (or 38) to the frame 24 is illustrated. As shown, the frame 24 may be considered to have an outer face 90 and an inner face 92. For connection with the roller 36, a threaded bore 94 extends from the outer face 90 of a side 30 and through the inner face 92 of the side 30. Further, the threaded bore 94 passes through the inner face 92 of the other side 32 and stops within the side 32. Structurally, the roller 36 includes a threaded shaft 96 that is received within the bore 94 and remains fixed in place during use. Also, the roller 36 includes a bushing 98 that rotates about the fixed shaft 96. As shown, the ring 10 further includes a plug 100 that engages the threads to seal and prevent contamination at the shaft 96. Also, the frame 24 forms a drain aperture 102 that extends from the threaded bore 94 to the outer face 90 of the side 32.

While the particular purse ring as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as defined in the appended claims.

What is claimed is:

1. A purse ring engageable with the bridle line of a seine for pursing the seine with a purse line during deep-sea fishing operations which comprises:
an oblong-shaped frame defining a plane and circumscribing an aperture, with the frame having a proximal end and a distal end interconnected by a first side and a second side;
a distal roller interconnecting the first side and the second side to bridge the aperture;
a proximal roller interconnecting the first side and the second side to bridge the aperture, wherein the rollers and the sides define a periphery around a passageway for receiving the purse line, and wherein a hard facing is positioned on the first side adjacent the distal roller to reduce wear on the frame;
a cable release arm pivotally mounted as a portion of the second side, wherein the cable release arm is canted, pivotable and operable to interrupt the periphery to move the purse line into and out of the passageway, wherein the cable release arm includes a pivot pin attached to the frame and a pivot member with a first end and a second end, wherein the first end is pivotably attached to the pivot pin for movement of the pivot member transverse to the plane;
a sleeve having a distal end and a flared proximal end and forming a channel therebetween for slidably receiving the pivot member to selectively engage the frame, wherein the sleeve forms a lateral opening to the channel and a notch with a sloped surface from the lateral opening to the distal end, wherein the sleeve has an extended position in which the distal end of the sleeve engages the frame to prevent movement of the pivot member, and wherein the sleeve has a retracted position in which the flared proximal end of the sleeve rides over the first end of the pivot member; and
a sleeve locking means slidably attached to the frame to hold the sleeve in its extended position, wherein the locking means comprises a slot defined by the frame, a pin slidingly received by the slot and extendable from the slot to engage the lateral opening in the sleeve, with the pin being biased to extend from the slot, and wherein the sloped surface of the notch automatically depresses the pin to align the pin with the lateral opening when the sleeve is moved to the extended position.

2. A purse ring as recited in claim 1 wherein the second side of the frame includes a hard facing adjacent the distal roller to reduce wear on the frame.

3. A purse ring as recited in claim 1 further comprising a side roller mounted on the first side of the frame adjacent the distal roller to reduce friction between the purse ring and the purse line, with the side roller being transverse to the distal roller.

4. A purse ring as recited in claim 3 wherein the side roller is substantially perpendicular to the distal roller.

5. A purse ring as recited in claim 4 wherein the distal roller is substantially parallel to the proximal roller.

6. A purse ring as recited in claim 1 wherein the sleeve defines a longitudinal axis, wherein the sleeve terminates at a distal end face forming a plane substantially perpendicular to the longitudinal axis, and wherein the notch is formed in the end face.

7. A purse ring as recited in claim 6 wherein the sloped surface of the notch forms a 45° angle with both the end face plane and the longitudinal axis.

8. A purse ring as recited in claim 7 wherein the lateral opening and the notch are axially aligned.

9. A purse ring as recited in claim 1 wherein the first end of the pivot member has an outer diameter D_{P}, wherein the sleeve has a first inner diameter D₁, and wherein the sleeve has a second inner diameter D₂ along the flared portion, with D₂>D₁≧D_{P}.

10. A purse ring as recited in claim 1 wherein the frame has an outer face and an inner face and forms at least one threaded bore extending from the outer face through the inner face of a selected side and through the inner face of the other side, wherein a drain aperture extends from the threaded bore to the outer face of the other side, wherein a selected roller includes a threaded shaft that is received in the bore, and a bushing for spinning on the shaft, and wherein the ring is provided with a plug for sealing the shaft in the bore.

11. A purse ring engageable with the bridle line of a seine for pursing the seine with a purse line during deep-sea fishing operations which comprises:
an oblong-shaped frame defining a plane and circumscribing an aperture, with the frame having a proximal end and a distal end interconnected by a first side and a second side;
a distal roller interconnecting the first side and the second side to bridge the aperture;
a proximal member interconnecting the first side and the second side to bridge the aperture, wherein the distal roller, the proximal member and the sides define a periphery around a passageway for receiving the purse line, and wherein a hard facing is positioned on the first side adjacent the distal roller to reduce wear on the frame;
a cable release arm pivotally mounted as a portion of the second side, wherein the cable release arm is canted, pivotable and operable to interrupt the periphery to move the purse line into and out of the passageway, wherein the cable release arm includes a pivot pin attached to the frame and a pivot member with a first end and a second end, wherein the first end is pivotably attached to the pivot pin for movement of the pivot member transverse to the plane;
a sleeve having a distal end and a flared proximal end and forming a channel therebetween for slidably receiving the pivot member to selectively engage the frame, wherein the sleeve forms a lateral opening to the channel, wherein the sleeve has an extended position in which the distal end of the sleeve engages the frame to prevent movement of the pivot member, and wherein the sleeve has a retracted position in which the flared proximal end of the sleeve rides over the first end of the pivot member; and
a sleeve locking means slidably attached to the frame to hold the sleeve in its extended position, wherein the locking means comprises a slot defined by the frame, a pin slidingly received by the slot and extendable from the slot to engage the lateral opening in the sleeve, with the pin being biased to extend from the slot.

12. A purse ring as recited in claim 11 wherein the sleeve forms a notch with a sloped surface from the lateral opening to the distal end, and wherein the sloped surface of the notch automatically depresses the pin to align the pin with the lateral opening when the sleeve is moved to the extended position.

13. A purse ring as recited in claim 12 wherein the sleeve defines a longitudinal axis, wherein the sleeve terminates at a distal end face forming a plane substantially perpendicular to the longitudinal axis, and wherein the notch is formed in the end face.

14. A purse ring as recited in claim 13 wherein the sloped surface of the notch forms a 45° angle with both the end face plane and the longitudinal axis.

15. A purse ring as recited in claim 14 wherein the lateral opening and the notch are longitudinally aligned.

16. A purse ring as recited in claim 11 wherein the first end of the pivot member has an outer diameter D_{P}, wherein the sleeve has a first inner diameter D₁, and wherein the sleeve has a second inner diameter D₂ along the flared portion, with D₂>D₁≧D_{P}.

17. A purse ring as recited in claim 11 wherein the frame has an outer face and an inner face and forms at least one threaded bore extending from the outer face through the inner face of a selected side and into the inner face of the other side, wherein a drain aperture extends from the threaded bore to the outer face of the other side, wherein the distal roller includes a threaded shaft that is received in the bore, and a bushing for spinning on the shaft; and wherein the ring is provided with a plug for sealing the shaft in the bore.

18. A purse ring engageable with the bridle line of a seine for pursing the seine with a purse line during deep-sea fishing operations which comprises:
an oblong-shaped frame defining a plane and circumscribing an aperture, with the frame having a proximal end and a distal end interconnected by a first side and a second side;
a distal roller interconnecting the first side and the second side to bridge the aperture;
a proximal roller interconnecting the first side and the second side to bridge the aperture, wherein the rollers and the sides define a periphery around a passageway for receiving the purse line, and wherein a hard facing is positioned on the first side adjacent the distal roller to reduce wear on the frame;
a cable release arm pivotally mounted as a portion of the second side, wherein the cable release arm is canted, pivotable and operable to interrupt the periphery to move the purse line into and out of the passageway, wherein the cable release arm includes a pivot pin attached to the frame and a pivot member with a first end and a second end, wherein the first end is pivotably attached to the pivot pin for movement of the pivot member transverse to the plane;
a sleeve having a distal end and a proximal end and forming a channel therebetween for slidably receiving the pivot member to selectively engage the frame, wherein the sleeve forms a lateral opening to the channel and a notch with a sloped surface from the lateral opening to the distal end, wherein the sleeve has an extended position in which the distal end of the sleeve engages the frame to prevent movement of the pivot member, and wherein the sleeve has a retracted position in which the distal end disengages from the frame; and
a sleeve locking means slidably attached to the frame to hold the sleeve in its extended position, wherein the locking means comprises a slot defined by the frame, a pin slidingly received by the slot and extendable from the slot to engage the lateral opening in the sleeve, with the pin being biased to extend from the slot, and wherein the sloped surface of the notch automatically depresses the pin to align the pin with the lateral opening when the sleeve is moved to the extended position.

19. A purse ring as recited in claim 18 further comprising a side roller mounted on the first side of the frame adjacent the distal roller to reduce friction between the purse ring and the purse line, with the side roller being transverse to the distal roller.

20. A purse ring as recited in claim 18 wherein the frame has an outer face and an inner face and forms at least one threaded bore extending from the outer face through the inner face of a selected side and through the inner face of the other side, wherein a drain aperture extends from the threaded bore to the outer face of the other side, wherein a selected roller includes a threaded shaft that is received in the bore, and a bushing for spinning on the shaft, and wherein the ring is provided with a plug for sealing the shaft in the bore.
